(19) United States
(12) Patent Application Publication
(10) Pub. No.: US 2007/0018565 A1
(43) Pub. Date: Jan. 25, 2007

(54) Electron emission device, electron emission type backlight unit and flat display apparatus having the same

(75) Inventors: Young-Suk Cho, Suwon-si (KR); Jae-Woo Bae, Suwon-si (KR); Ik-Chul Lim, Suwon-si (KR); Yong-Soo Choi, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/477,458

(22) Filed: Jun. 30, 2006

(30) Foreign Application Priority Data
Jul. 19, 2005 (KR) 2005-65428

(51) Int. Cl. H01J 1/62

(52) U.S. Cl. 313/497

(57) ABSTRACT

An electron emission device with improved electron emission efficiency and an electron emission type backlight unit with a new structure using the electron emission device in which an electric field between an anode electrode and a cathode electrode is effectively blocked, and electrons are emitted continuously and stably by a low gate voltage thereby improving light-emitting uniformity and light-emitting efficiency. Also provided is a flat display apparatus employing the electron emission type backlight unit having the electron emission device. The electron emission device includes a base substrate; a cathode electrode formed on the base substrate; a gate electrode that is formed on the base substrate and alternately separated from the cathode electrode when there are more than one; an electron emission layer disposed on a surface of the cathode electrode; and a supplementary electrode formed on the cathode electrode or the gate electrode and is higher than the corresponding electrode.

### CROSS-REFERENCE TO RELATED APPLICATIONS

This application claims the benefit of Korean Application No. 2005-65428, filed Jul. 29, 2005, in the Korean Intellectual Property Office, the disclosure of which is incorporated herein in its entirety by reference.

### BACKGROUND OF THE INVENTION

1. Field of the Invention

Aspects of the present invention relate to an electron emission device, an electron emission type backlight unit, and a flat display apparatus having the same, and more particularly, to an electron emission device with improved electron emission efficiency and light-emitting uniformity, an electron emission type backlight unit employing the electron emission device, and a flat display apparatus having the electron emission type backlight unit.

2. Description of the Related Art

Generally electron emission devices can be classified into electron emission devices using a thermionic cathode and electron emission devices using a cold cathode as an electron emission source. Electron emission devices that use a cold cathode as an electron emission source include field emitter array (FEA) type devices, surface conduction emitter (SCE) type devices, metal insulator metal (MIM) type devices, metal insulator semiconductor (MIS) type devices, ballistic electron surface emitting (BSE) type devices, etc. Aspects of the present invention relates to the FEA type device.

An FEA type electron emission device uses the principle that, when a material having a low work function or a high β function is used as an electron emission source, the material readily emits electrons in a vacuum due to an electric potential. FEA devices that employ a tapered tip structure formed of, for example, Mo, Si as a main component, a carbon group material such as graphite, diamond-like carbon (DLC), etc., or a nano structure such as nanotubes, nano wires, etc., have been developed.

FEA type electron emission devices can be classified into top gate types and under gate types according to the arrangement of a cathode electrode and a gate electrode. FEAs can also be classified into two-electrode, three-electrode, or four-electrode type emission devices according to the number of electrodes.

Studies have been conducted into ways of using an electron emission device as a backlight unit of a non-emissive display device.

FIG. 1 illustrates a conventional electron emission type backlight unit 3.

Referring to FIG. 1, the conventional electron emission type backlight unit 3 includes a front panel 1 and an electron emission device 2. The front panel 1 includes a front substrate 90, an anode electrode 80 formed on a lower surface of the front substrate 90, and a phosphor layer 70 coated on the anode electrode 80.

The electron emission device 2 includes a base substrate 10 that faces and is parallel to the front substrate 90, a cathode electrode 20 formed in strips on the base substrate 10, a gate electrode 30 that is formed in strips and is parallel to the cathode electrode 20, and electron emission layers 40 and 50 respectively formed around the cathode electrode 20 and the gate electrode 30. An electron emission gap G is formed between the electron emission layers 40 and 50 surrounding the cathode electrode 20 and the gate electrode 30.

A vacuum lower than the ambient air pressure is maintained in the space between the front panel 1 and the electron emission device 2, and a spacer 60 is disposed between the front panel 1 and the electron emission device 2 in order to support the pressure generated by the vacuum between the front panel 1 and the electron emission device 2 and to secure a light emitting space 103.

In the above-described electron emission type backlight unit 3, electrons are emitted from one of the electron emission layers 40 and 50, that is, from the electron emission layer 40 that is formed around the cathode electrode 20 by an electric field generated between the gate electrode 30 and the cathode electrode 20. The emitted electrons travel toward the gate electrode 30 initially and then are pulled by the strong electric field of the anode electrode 80 and move toward the anode electrode 80.

However, an electric field generated between the anode electrode 80 and the cathode electrode 20 interferes with the electric field between the gate electrode 30 and the cathode electrode 20 and thus a diode discharge, that is, electron emission and electron acceleration due to the electric field of the anode electrode 80, occurs.

In addition, due to the light-emitting characteristic of phosphor materials, during a predetermined period of time in which light is being emitted by electrons that are incident on the phosphor materials, other incident electrons cannot contribute to light emitting. Thus, light-emitting efficiency is not improved by increasing incident electrons beyond this saturation level on the phosphor layer 70 and electron emission by a high anode voltage is detrimental from an energy efficiency aspect. In other words, to achieve optimum efficiency, electrons must be emitted stably and steadily by a low gate voltage and at the same time the emitted electrons must be uniformly accelerated by a strong anode voltage. However, when electrons are emitted by a strong anode voltage, efficient electron emission and light emitting become impossible. Thus an electron emission type backlight unit with a new structure in which an electric field between the anode electrode 80 and the cathode electrode 20 can be blocked is required.

### SUMMARY OF THE INVENTION

Aspects of the present invention provide an electron emission device with improved electron emission efficiency and an electron emission type backlight unit with a new structure using the electron emission device in which an electric field between an anode electrode and a cathode electrode is effectively blocked, and electrons are emitted continuously and stably by a low gate voltage thereby improving light-emitting uniformity and light-emitting efficiency.

Aspects of the present invention also provide a flat display apparatus employing the electron emission type backlight unit.

According to an aspect of the present invention, there is provided an electron emission device comprising: a base substrate; a cathode electrode formed on the base substrate; a gate electrode that is formed on the base substrate and separated from the cathode electrode, and when there is more than one cathode and/or gate electrode, the gate electrode alternates with the cathode electrode; an electron emission layer disposed on a surface of the cathode electrode; and a supplementary electrode that is formed on one of the cathode electrode and the gate electrode and extends farther from the base substrate than the cathode electrode and the gate electrode. While not required in all aspects, the supplementary electrode may be formed on the cathode electrode and the gate electrode.

While not required in all aspects, the electron emission layer may be formed on both sides of the cathode electrode. The electron emission layer may be disposed on one side of the cathode electrode. The electron emission layer may be disposed to cover the cathode electrode.

While not required in all aspects, the electron emission layer may comprise an electron emission material selected from a carbon type material and a nano material, wherein the carbon type material is selected from the group consisting of carbon nanotubes, graphite, diamond, and diamond-like carbon and the nano material is selected from the group consisting of nanotubes, nanowires, nanorods, and nanoneedles.

While not required in all aspects, an insulating layer having a predetermined thickness may be formed between the cathode electrode and the gate electrode.

While not required in all aspects, the cathode electrode and the gate electrode may be formed in strips.

While not required in all aspects, protrusions may be formed to a predetermined length and width in the cathode electrode, and in this case, concaves corresponding to the protrusions formed in the cathode electrode may be formed in the gate electrode.

While not required in all aspects, concaves may be formed to a predetermined length and width in the cathode electrode, and in this case, protrusions corresponding to the concaves formed in the cathode electrode may be formed in the gate electrode.

While not required in all aspects, curved surfaces with a predetermined curvature may be formed in the cathode electrode. The curved surfaces may be convex toward the gate electrode or concave toward the gate electrode.

While not required in all aspects, the cathode electrode has planes with concave and convex surfaces on both side thereof, and the gate electrode may have a plane form corresponding to the plane form of the cathode electrode to be substantially separated from the cathode electrode by a predetermined distance.

While not required in all aspects, the both curved surfaces of the cathode electrode may be symmetrical around a center of the cathode electrode or have substantially the same plane form around a center line of the electrode. Also, curved surfaces corresponding to the curved surface formed in the cathode electrode may be formed in the gate electrode.

According to an aspect of the invention, the supplementary electrode may be formed on the cathode or on the gate electrode. While not required in all aspects, the supplementary electrode has a horizontal cross-section corresponding to the plane form of the cathode electrode or the gate electrode which may be electrically connected thereto.

According to another aspect of the present invention, there is provided an electron emission type backlight unit comprising: a front substrate comprising an anode electrode and a phosphor layer; a base substrate separated from the front substrate by a predetermined distance; a plurality of cathode electrodes formed on the base substrate; a plurality of gate electrodes alternately formed on the base substrate and separated from the cathode electrodes; an electron emission layer formed at a side of each of the cathode electrodes toward the gate electrodes; a spacer maintaining a distance between the front substrate and the base substrate; and a supplementary electrode that is formed on each of the cathode electrodes and extends farther from the base substrate than the cathode electrodes.

According to another aspect of the present invention, there is provided a flat display apparatus comprising: an electron emission type backlight unit; and a non-emissive display device that is formed in front of the electron emission type backlight unit to control light supplied from the electron emission device to realize an image.

While not required in all aspects, the non-emissive display device may be a liquid display device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a conventional electron emission type backlight unit;

FIG. 2 is a perspective view of an electron emission type backlight unit according to an embodiment of the present invention;

FIG. 3 is a cross-sectional view of the electron emission type backlight unit of FIG. 2 cut along a line III-III;

FIGS. 4 through 6 are cross-sectional views illustrating electron emission devices constituting an electron emission type backlight unit, according to various embodiments of the present invention;

FIG. 7 is a plan view of the electron emission device of FIG. 3 cut along a line VII-VII;

FIGS. 8 through 14 are plan views illustrating electron emission devices constituting an electron emission type backlight unit, according to various embodiments of the present invention;

FIG. 15 is a perspective view of a flat display apparatus according to an embodiment of the present invention;

FIG. 16 is a partial cross-sectional view of the flat display apparatus of FIG. 15 cut along a line XVI-XVI; and

FIG. 17 is a plan view of an image display device according to an embodiment of the present invention.

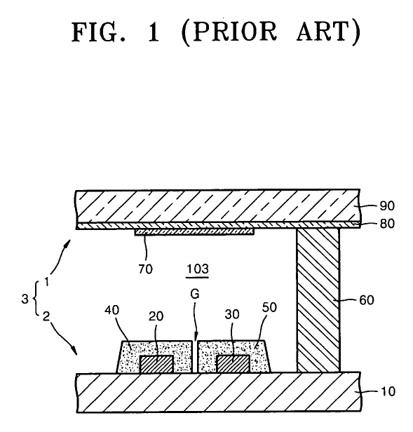

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

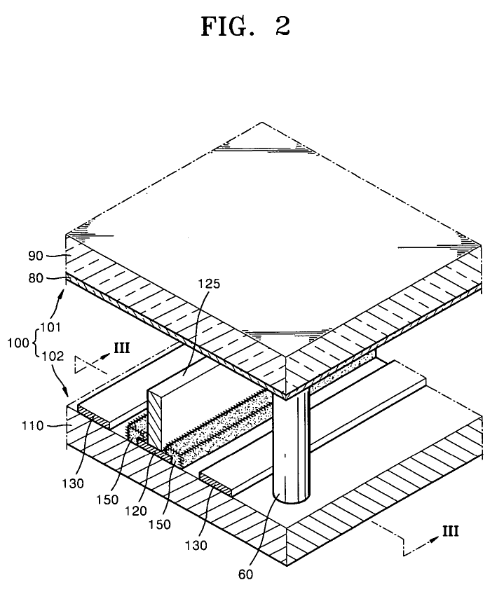

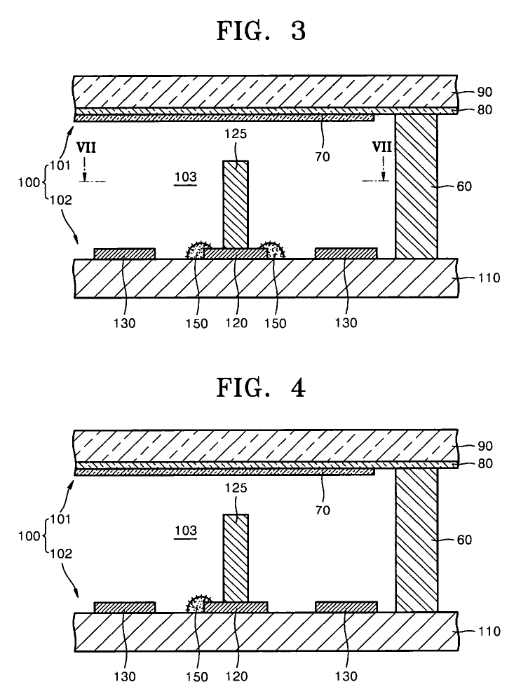

FIG. 2 is a perspective view of an electron emission type backlight unit 100 according to an embodiment of the present invention; FIG. 3 is a cross-sectional view of the electron emission type backlight unit 100 of FIG. 2 cut along a line III-III.

Referring to FIGS. 2 and 3, the electron emission type backlight unit 100 includes a front panel 101 and an electron emission device 102 that face each other and are disposed parallel to each other to form a vacuum space 103, and a spacer 60 which maintains a distance between the front panel 101 and the electron emission device 102.

The front panel 101 includes a front substrate 90, an anode electrode 80 disposed on a lower surface of the front substrate 90, and a phosphor layer 70 (see FIG. 3) disposed on a lower surface of the anode electrode 80.

The electron emission device 102 includes a base substrate 110 disposed at a predetermined interval from and parallel to the front substrate 90 whereby the vacuum space 103 is formed between the front panel 101 and the electron emission device 102, a cathode electrode 120 formed on a surface of the base substrate 110, a gate electrode 130 separated from the cathode electrode 120 and parallel thereto, an electron emission layer 150 disposed on a side of the cathode electrode 120 to face the gate electrode 130, and a supplementary electrode 125 that is formed on an upper surface of the cathode electrode 120.

The anode electrode 80 applies a high voltage which is necessary to accelerate electrons emitted from the electron emission layer 150 so that the electrons collide with the phosphor layer 70 at a high velocity. The phosphor layer 70 is excited by the electrons and changes from a high potential to a low potential, thus emitting visible light.

While not required in all aspects, when there are more than one cathode electrode 120 and/or gate electrode 130, the cathode electrode 120 and the gate electrode 130 are alternately arranged on the base substrate 110 and the electron emission layer 150 may be formed on both sides of the cathode electrode 120.

The vacuum space 103 between the front panel 101 and the electron emission device 102 is maintained at a lower pressure than the ambient air pressure, and the spacer 60 is disposed between the front panel 101 and the electron emission device 102 to sustain the pressure between the front panel 101 and the electron emission device 102 generated by a vacuum and to partition the vacuum space 103. The spacer 60 is formed of insulating material such as ceramics or glass that is not electrically conductive. Electrons may be accumulated during the operation of the electron emission type backlight unit 100 on the spacer 60, and to emit these accumulated electrons, the spacer 60 may be coated with a conductive material.

The cathode electrode 120 and the gate electrode 130 form an electric field to easily emit electrons from the electron emission layer 150.

The supplementary electrode 125 is electrically connected to the cathode electrode 120 and extends toward the anode electrode 80 and thus prevents the electric field generated between the anode electrode 80 and the cathode electrode 120 from interfering with the electron emission layer 150. Thus, the electron emission is controlled by a voltage applied to the gate electrode 130 and the electric field formed by the anode electrode 80 only accelerates the emitted electrons. Thus the electron emission efficiency and the light-emitting efficiency of the phosphor layer are improved and the electron emission uniformity and light-emitting uniformity increase.

While not required in all aspects, an insulating layer having a predetermined thickness may be further disposed between the cathode electrode 120 and the gate electrode 130. The insulating layer (not shown) insulates the electron emission layer 150 and the gate electrode 130 and can prevent a short circuit between the gate electrode 130 and the cathode electrode 120.

Hereinafter, materials of components that constitute the above described electron emission backlight unit 100 will be described.

While not required in all aspects, the front substrate 90 and the base substrate 110 are board members having a predetermined thickness and may be formed of a quartz glass, a glass including an impurity such as a small amount of Na, a flat glass, a glass substrate coated with SiO₂, an oxide aluminum substrate or a ceramic substrate.

While not required in all aspects, the cathode electrode 120, the gate electrode 130, and the supplementary electrode 125 may be formed of general conductive materials. Examples of the general conductive materials include a metal (e.g., Al, Ti, Cr, Ni, Au, Ag, Mo, W, Pt, Cu, Sn, In, Sb, or Pd) or its alloy, a conductive material formed of either metal such as Pd, Ag, RuO₂, and Pd—Ag or its oxide and glass, a transparent conductive material such as ITO, In₂0₃ and SnO₂, and a semiconductor material such as polysilicon.

While not required in all aspects, the electron emission layer 150, which emits electrons due to an electric field may be formed of any electron emission material that is nano-sized. Carbon type materials that have a small work function and a high β a function such as carbon nano tubes (CNT), graphite, diamond and diamond-like carbon may be preferable. CNTs particularly have a good electron emission property and can be driven at a low voltage. Therefore, devices using CNTs as an electron emission material can be applied to a larger electron emission display device.

The above-described embodiment of the electron emission type backlight unit 100 operates as follows.

For electron emission, a negative (−) voltage is applied to the cathode electrode 120 and a positive (+) voltage is applied to the gate electrode 130 to emit electrons from the electron emission layer 150 formed on the cathode electrode 120. Also, a strong (+) voltage is applied to the anode electrode 80 to accelerate the electrons emitted toward the anode electrode 80. Thus electrons are emitted from the electron emission layer 150 and travel toward the gate electrode 130 and then are accelerated toward the anode electrode 80. The electrons accelerated toward the anode electrode 80 collide with the phosphor layer 70 at the anode electrode 80 and thus generate visible light.

Since the supplementary electrode 125 is formed closer to the anode electrode 80 than the cathode electrode 120, the electric field formed by the anode electrode 80 can be prevented from interfering with the electric field between the cathode electrode 120 and the gate electrode 130. Thus the anode electrode 80 only accelerates the electrons, thereby making it easy to control the electron emission with the gate electrode 130, thereby maximizing the light-emitting uniformity and the light-emitting efficiency of the phosphors and preventing diode discharge.

Hereinafter, other example embodiments of the electron emission device illustrated in FIGS. 2 and 3 will be described.

FIGS. 4 through 6 are cross-sectional views illustrating electron emission devices constituting an electron emission type backlight unit, according to various embodiments of the present invention.

As illustrated in FIG. 4, the electron emission layer 150 may be formed only at one side of the cathode electrode 120. Also, as illustrated in FIG. 5, the electron emission layer 150 may be disposed to cover the cathode electrode 120. Numerous arrangements of the electron emission layer 150 may be possible according to the manufacturing process or the amount of the electron emission material.

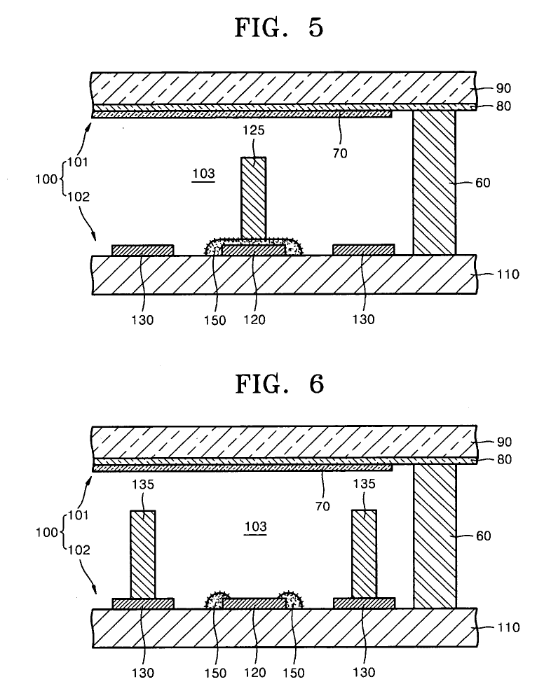

Meanwhile, as illustrated in FIG. 6, a supplementary electrode 135 may be formed not on the cathode electrode 120, but on each of the gate electrodes 130 according to an aspect of the invention. The supplementary electrode 135 in this case also shields the electric field of the anode electrode 80 and helps the gate electrodes 130 to easily control the electron emission.

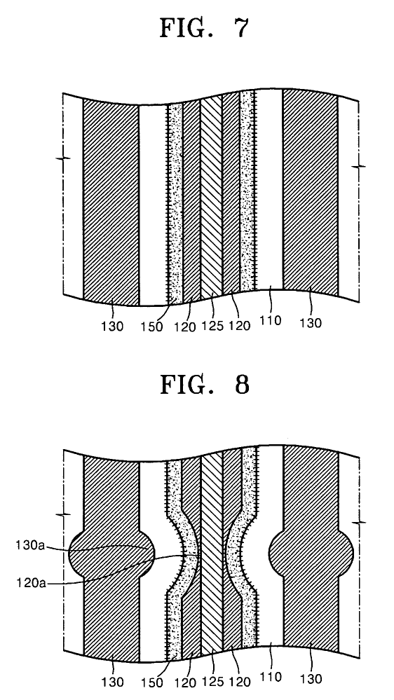

FIG. 7 is a plan view of the electron emission device 102 cut along a line VII-VII of FIG. 3; FIGS. 8 through 14 are plan views illustrating an electron emission device constituting an electron emission type backlight unit, according to various embodiments of the present invention.

As illustrated in FIG. 7, the cathode electrode 120 and the gate electrode 130 may be arranged in striped patterns and formed parallel to each other. Also, in order to increase the surface area of the electron emission layer 150, as illustrated in FIGS. 8 through 13, protrusions, concaves, or curved surfaces may be formed in the cathode electrode 120 and the gate electrode 130.

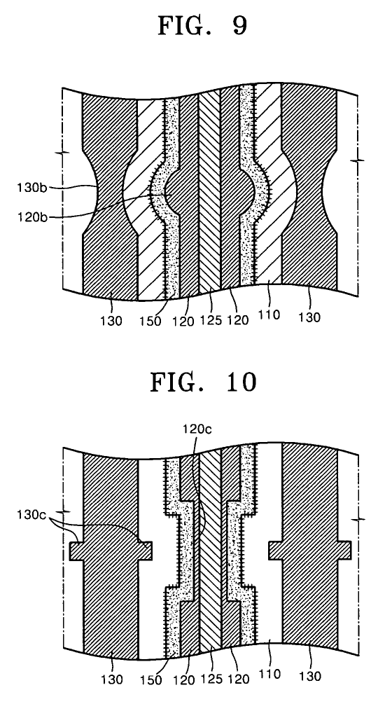

In other words, as illustrated in FIGS. 8 and 9, the cathode electrode 120 includes curved surfaces 120a and 120b having a predetermined curvature at the gate electrode 130, and the electron emission layer 150 can be formed in the curved surfaces 120a and 120b. The curved surfaces 120a and 120b may be concave surfaces 120a (see FIG. 5) toward the gate electrode 130 or convex surfaces 120b (see FIG. 6) toward the gate electrode 130. In this case, curved surfaces 130a and 130b corresponding, respectively, to the curved surfaces 120a and 120b may be formed in the gate electrode 130.

As illustrated in FIG. 10, the cathode electrode 120 includes a concave 120c having a predetermined length and width at the gate electrode 130 and an electron emission layer 150 may be formed on the surface of the concave 120c. Then a protrusion 130c corresponding to the shape of the concave 120c is formed in the gate electrode 130.

Alternatively, as illustrated in FIG. 11, the cathode electrode 120 includes a protrusion 120d and an electron emission layer 150 may be formed on the protrusion 120d. Then a concave 130d corresponding to the shape of the protrusion 120d is formed in the gate electrode 130.

The shape of the concaves and protrusions formed in the cathode electrode 120 and the gate electrode 130 is not limited to a rectangle and may be a trapezoid or other polygonals.

Also, in the above embodiments, the supplementary electrodes 125 are illustrated as being linear, but the shape of the supplementary electrodes 125 may have a horizontal cross-section corresponding to the plan surface of the cathode electrodes 120.

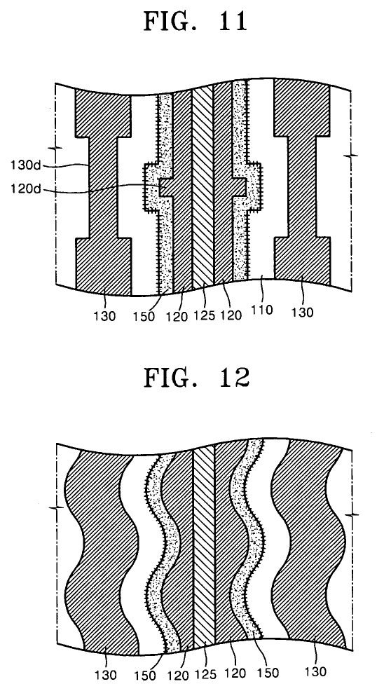

As illustrated in FIGS. 12 and 13, the planes of the cathode electrode 120 and the gate electrode 130 may be continuously curved. In this case, as illustrated in FIG. 12, both planes on both sides of the cathode electrode 120 may be formed to have the same shape around the center of the cathode electrode 120. Also, as illustrated in FIG. 13, the cathode electrode 120 and the gate electrode 130 have a symmetric plane around the center of the cathode electrode 120. As illustrated in FIGS. 12 and 13, when the cathode electrode 120 and gate electrode 130 have continuously curved surfaces, the surface area for an electron emission layer is increased and thus the current density can be maximized.

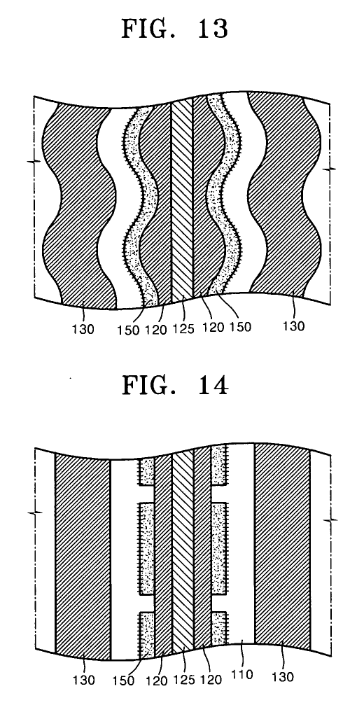

Meanwhile, as illustrated in FIG. 14, the electron emission layer 150 formed on the cathode electrode 120 may be arranged at a regular interval. In this case, the amount of the electron emission material constituting the electron emission layer 150 can be reduced. In other words, the phosphor layer 70 emits visible light in proportion to the current density to a certain level of the current density, but over a certain saturated current density, the intensity of the visible light does not increase with increasing current density. Accordingly, unnecessary consumption of the electron emission material can be reduced by optimizing the current density which can maximize the visible light efficiency in the phosphor layer 70 included in the electron emission type backlight unit. Also, if it is difficult to manufacture the electron emission layer 150 continuously in the manufacturing process, the electron emission layer 150 in certain predetermined portions can be manufactured discontinuously.

According to an aspect of the present invention, the above-described electron emission type backlight unit 100 may be used as a backlight unit for a liquid crystal display and in this case, the cathode electrode 120 and the gate electrode 130 are disposed substantially parallel to each other. Also, the phosphor layer 70 may be formed of a phosphor emitting visible light of a desired color or a mixture of red, green, and blue light emitting phosphors in a proper ratio to obtain white light.

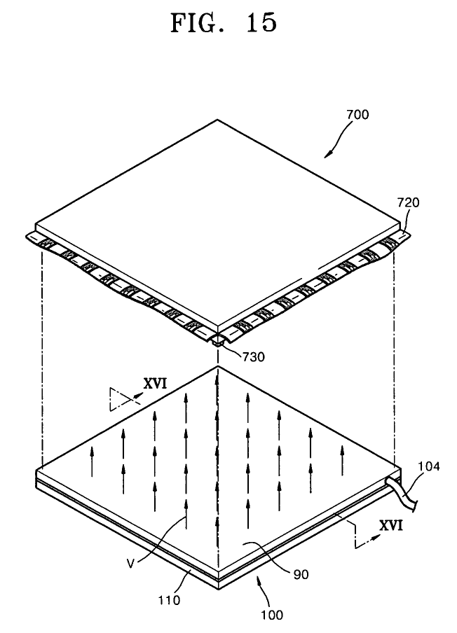

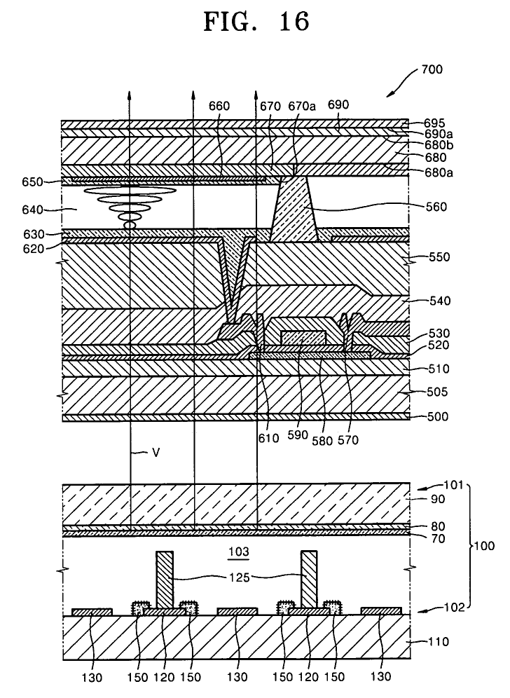

FIG. 15 is a perspective view of a flat display apparatus according to an embodiment of the present invention; and FIG. 16 is a partial cross-sectional view of the flat display apparatus of FIG. 15 cut along a line XVI-XVI.

As illustrated in FIG. 15, the flat display apparatus of the present embodiment is a non-emissive display device including a liquid crystal display device 700 and a backlight unit 100 supplying light to the liquid crystal display device 700. A soft print circuit board 720 transmitting an image signal is attached to the liquid display device 700, and a spacer 730 is disposed to maintain a distance from the backlight unit 100 disposed at the back of the liquid crystal display device 700. Although only one spacer 730 is shown in FIG. 15, additional spacers 730 may be arranged to maintain the distance between the backlight unit 100 and the liquid crystal display device 700.

The backlight unit is one of the electron emission type backlight units 100 according to the previously described embodiments of the present invention and is supplied with power through a connection cable 104 and emits visible light V through a front panel 90 to supply the visible light V to the liquid crystal display device 700.

Hereinafter, the structure and the operation of the flat display apparatus of the present embodiment will be described with reference to FIG. 16.

The electron emission type backlight unit 100 illustrated in FIG. 16 may be one of the electron emission type backlight units 100 of the various embodiments of the present invention. As illustrated in FIG. 16, the electron emission type backlight unit 100 is formed of a front panel 101 and an electron emission device 102 which are separated from each other by a predetermined distance. The front panel 101 and the electron emission device 102 of the present embodiment have the same structure as those of the previous embodiments, and thus descriptions thereof will not be repeated. The electric field formed by the cathode electrode 120 and the gate electrode 130 disposed in the electron emission device 102 causes electrons to be emitted. The electrons are accelerated by the electric field formed by the anode electrode 80 disposed on the front panel 101 and the electrons collide with the phosphor layer 70, thus generating visible light V. The visible light V travels toward the liquid crystal display device 700.

The liquid crystal display device 700 includes a front substrate 505, a buffer layer 510 formed on the front substrate 505, and a semiconductor layer 580 formed in a predetermined pattern on the buffer layer 510. A first insulating layer 520 is formed on the semiconductor layer 580, a gate electrode 590 is formed on the first insulating layer 520 in a predetermined pattern, and a second insulating layer 530 is formed on the gate electrode 590. After the second insulating layer 530 is formed, the first and second insulating layers 520 and 530 are etched using a process such as dry etching or similar process and thus a portion of the semiconductor layer 580 is exposed. A source electrode 570 and a drain electrode 610 are formed in a predetermined area including the exposed portion of the semiconductor layer 580. After the source electrode 570 and the drain electrode 610 are formed, a third insulating layer 540 is formed, and a planarization layer 550 is formed on the third insulating layer 540. A first electrode 620 is formed in a predetermined pattern on the planarization layer 550, and a portion of the third insulating layer 540 and the planarization layer 550 is etched and thus a conduction path to connect the drain electrode 610 and the first electrode 620 is formed. A transparent base substrate 680 is formed separately from the front substrate 505 and a color filter layer 670 is formed on a lower surface 680a of the transparent base substrate 680. A second electrode 660 is formed on a lower surface 670a of the color filter layer 670 and a first alignment layer 630 and a second alignment layer 650 that align the liquid crystal layer 640 are formed on the surfaces facing the first electrode 620 and the second electrode 660. A first polarization layer 500 is formed on a lower surface of the front substrate 505 and a second polarization layer 690 is formed on a top surface 680b of the base substrate and a protection film 695 is formed on a top surface 690a of the second polarization layer 690. A spacer 560 which partitions the liquid crystal layer 640 is formed between the color filter layer 670 and the planarization layer 550.

The liquid crystal display device 700 operates as follows. An external signal controlled by the gate electrode 590, the source electrode 570, and the drain electrode 610 forms a potential difference between the first electrode 620 and the second electrode 660 and the potential difference determines the alignment of the liquid crystal layer 640. According to the alignment of the liquid crystal layer 640, the visible light V supplied by the backlight unit 100 is shielded or transmitted. The light is transmitted through the color filter layer 670 and radiates color, thus realizing an image.

FIG. 16 illustrates a liquid crystal display 700 (especially a TFT-LCD), however, a non-emissive display device for the flat display apparatus of the present invention is not limited thereto.

The flat display apparatus employing the electron emission type backlight unit 100 according to the current embodiment of the present invention has increased image brightness and life span since the backlight unit has improved brightness and increased life span.

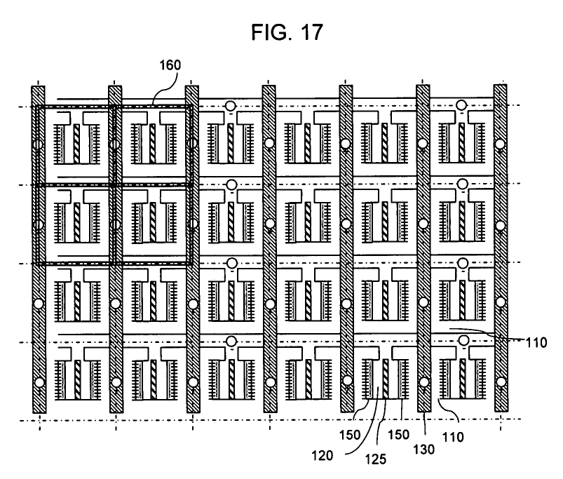

Also, as described above, the electron emission device 102 with the above-described configuration can be used for a display device according to an embodiment of the invention. In this case, the electron emission device may have a structure in which the gate electrode and the cathode electrode are formed in strips and cross each other, and this is advantageous for applying signals to realize an image. For example, when the cathode electrode is formed in strips extending in one direction, the gate electrode may be formed of a main electrode crossing the cathode electrode and a branch electrode extending from the main electrode to face the cathode electrode. The arrangement of the cathode electrode and the gate electrode, of course, may be exchanged as shown in FIG. 17. When a color display device is realized, red, green, and blue light emitting phosphor materials are formed in the vacuum space 103 forming a unit pixel 160 under the anode electrode 80.

As described above, a supplementary electrode is arranged close to the anode electrode such that the electric field of the anode electrode is prevented from interfering with the electric field between the cathode electrode and the gate electrode according to an embodiment of the present invention. Thus the anode electrode only accelerates electrons and the gate electrode can easily control the electron emission, thereby achieving light-emitting uniformity and maximizing the light-emitting efficiency of the phosphors.

Also, while not required in all aspects, curved surfaces, protrusions, or concaves are formed in the cathode electrode and the gate electrode which are arranged in strips and thus the surface area of the electron emission layer is increased, thereby increasing the electron emitting efficiency.

Meanwhile, when a backlight is formed using the electron emission device according to aspects of the present invention, a display apparatus employing the backlight unit can have improved brightness and light-emitting efficiency.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An electron emission device comprising:
a base substrate;
a cathode electrode formed on the base substrate;
a gate electrode that is formed on the base substrate and separated from the cathode electrode;
an electron emission layer disposed on a surface of the cathode electrode; and
a supplementary electrode that is formed on one of the cathode electrode and the gate electrode and extends farther from the base substrate than the cathode electrode and the gate electrode.

2. The electron emission device of claim 1, wherein the cathode electrode and the gate electrode are plural in number and alternately arranged, wherein the supplementary electrodes are respectively formed on one or more of the cathode electrodes, one or more of the gate electrodes, or a combination thereof.

3. The electron emission device of claim 1, wherein the electron emission layer is formed on both sides of the cathode electrode.

4. The electron emission device of claim 1, wherein the electron emission layer is disposed on only one side of the cathode electrode.

5. The electron emission device of claim 1, wherein the electron emission layer is disposed to cover the cathode electrode.

6. The electron emission device of claim 1, wherein the electron emission layer is discontinuously formed at a regular interval on the cathode electrode.

7. The electron emission device of claim 1, wherein the electron emission layer comprises an electron emission material selected from a carbon type material and a nano material, wherein the carbon type material is selected from the group consisting of carbon nanotubes, graphite, diamond, and diamond-like carbon and the nano material is selected from the group consisting of nanotubes, nanowires, nanorods, and nanoneedles.

8. The electron emission device of claim 1, wherein the cathode electrode, the gate electrode and the supplementary electrode are electrically conductive materials.

9. The electron emission device of claim 1, further comprising an insulating layer having a predetermined thickness and formed between the cathode electrode and the gate electrode.

10. The electron emission device of claim 1, wherein the cathode electrode and the gate electrode are formed in strips.

11. The electron emission device of claim 10, wherein the cathode electrode and the gate electrode are formed parallel to each other.

12. The electron emission device of claim 1, wherein protrusions are formed to a predetermined length and width on the cathode electrode.

13. The electron emission device of claim 12, wherein the protrusions have a polygonal shape.

14. The electron emission device of claim 1, wherein concaves are formed to a predetermined length and width in the cathode electrode.

15. The electron emission device of claim 14, wherein the concaves have a polygonal shape.

16. The electron emission device of claim 1, wherein curved surfaces with a predetermined curvature are formed in the cathode electrode.

17. The electron emission device of claim 16, wherein the curved surfaces of the cathode electrode are continuously curved.

18. The electron emission device of claim 16, wherein the curved surfaces are convex toward the gate electrode.

19. The electron emission device of claim 16, wherein the curved surfaces are concave toward the gate electrode.

20. The electron emission device of claim 1, wherein the cathode electrode has planes with concave and convex surfaces on both sides thereof.

21. The electron emission device of claim 20, wherein both curved surfaces of the cathode electrode are symmetrical around a center of the cathode electrode.

22. The electron emission device of claim 20, wherein both curved surfaces of the cathode electrode have substantially the same plane form around a center line of the electrode.

23. The electron emission device of claim 1, wherein the gate electrode has a plane form corresponding to the plane form of the cathode electrode to be substantially separated from the cathode electrode by a predetermined distance.

24. The electron emission device of claim 1, wherein the supplementary electrode is formed on the cathode electrode.

25. The electron emission device of claim 1, wherein the supplementary electrode is formed on the gate electrode.

26. The electron emission device of claim 1, wherein the supplementary electrode has a horizontal cross-section corresponding to the plane form of the cathode electrode or the gate electrode which is electrically connected thereto.

27. An electron emission type backlight unit comprising:
a front substrate comprising an anode electrode and a phosphor layer;
a base substrate separated from the front substrate by a predetermined distance;
a plurality of cathode electrodes formed on the base substrate;
a plurality of gate electrodes alternately formed on the base substrate and separated from the cathode electrodes;
an electron emission layer formed at a side of each of the cathode electrodes toward the gate electrodes;
a spacer maintaining a distance between the front substrate and the base substrate; and
supplementary electrodes respectively formed on each of the cathode electrodes and extend farther toward the anode electrode than the cathode electrodes.

28. The electron emission type backlight unit of claim 27, wherein the cathode electrodes and the gate electrodes are arranged in a striped pattern and cross each other, wherein:
the cathode electrodes have respective first branch electrodes extending to face the gate electrodes;
the gate electrodes have the first branch electrodes respectively extending to face the cathode electrodes; or
the cathode electrodes have the first branch electrodes respectively and the gate electrodes have respective second branch electrodes extending to face the first branch electrodes of the cathode electrodes.

29. The electron emission type backlight unit of claim 27, wherein the phosphor layer is red, green, and blue light-emitting to form a unit pixel.

30. The electron emission type backlight unit of claim 27, wherein the supplementary electrode is formed on each of the gate electrodes and extends farther toward the anode than the gate electrodes.

31. The electron emission type backlight unit of claim 27, further comprising an insulating layer having a predetermined thickness and formed between the cathode electrode and the gate electrode.

32. A flat display apparatus comprising:
an electron emission type backlight unit comprising:
a front substrate comprising an anode electrode and a phosphor layer,
a base substrate separated from the front substrate by a predetermined distance,
a plurality of cathode electrodes formed on the base substrate,
a plurality of gate electrodes alternately formed on the base substrate and separated from the cathode electrodes,
an electron emission layer formed at a side of each of the cathode electrodes toward the gate electrodes,
a spacer maintaining a distance between the front substrate and the base substrate, and
supplementary electrodes respectively formed on each of the cathode electrodes and extend farther toward the anode electrode than the cathode electrodes; and
a non-emissive display device that is formed in front of the electron emission type backlight unit and controls light supplied from the electron emission device to realize an image.

33. The flat display apparatus of claim 32, wherein the non-emissive display device is a liquid display device.

34. An electron emission type backlight unit comprising:
a first substrate comprising an anode electrode and a phosphor layer;
a base substrate separated from the first substrate;
a cathode electrode arranged on the base substrate;
a gate electrode arranged on the base substrate, separated from the cathode electrode;
an electron emission layer that is formed on a side of the cathode electrode and faces the gate electrode;
a spacer to maintain a distance between the first substrate and the base substrate; and
a supplementary electrode formed on one of the cathode electrode, the gate electrode, or a combination thereof to shield the cathode electrode from the anode electrode.

35. The electron emission type backlight unit of claim 34, wherein the supplementary electrode is formed to be closer to the anode electrode than the cathode and the gate electrodes are to the anode electrode.
